(19) United States
(12) Patent Application Publication
(10) Pub. No.: US 2001/0023400 A1
(43) Pub. Date: Sep. 20, 2001

(54) Collectively functioning bundle of telephone and network services

(75) Inventors: Alexander Kurganov, Buffalo Grove, IL (US); Harold E. Poel, Sullivans Island, NC (US)

Correspondence Address: S.Z. Szczepanski, Esq., Jenkens & Gilchrist, P.C., Suite 3200, 1445 Ross Avenue, Dallas, TX, 75202-2799, US

(73) Assignee: WEBLEY SYSTEMS, INC.

(21) Appl. No.: 09/777,025

(22) Filed: Feb. 5, 2001

Related U.S. Application Data
(60) Provisional application No. 60/180,558, filed on Feb. 4, 2000.
(60) Provisional application No. 60/180,345, filed on Feb. 4, 2000.

(51) Int. Cl. G10L 11/00; G10L 21/00

(52) U.S. Cl. 704/270.1

(57) ABSTRACT

The present invention relates to a unified communications system. The communications system provides a variety of different communication services to a user from a single service provider. These services include local telephone service, long distance, cellular telephone service, Internet access, voice mail, email, facsimile service, and paging services. Each of the different communication services are linked together by a control system operated by a single service provider. The unified system allows users to easily and economically transfer information received by one of the communication services to a second communication services.

### CROSS-REFERENCE TO RELATED APPLICATIONS

This application claims the benefit of priority from U.S. Provisional Application Serial No. 60/180,558, filed Feb. 4, 2000 entitled “Collectively Functioning Bundle of Telephone and Network Services” and U.S. Provisional Application Serial No. 60/180,345, filed Feb. 4, 2000 entitled “Reduced Cost Method for Transferring Telephone Calls”.

### FIELD OF INVENTION

The present invention relates generally to a system and method for providing communication services. In particular, the present invention relates to a method for providing integrated Internet and telecommunications services from a common provider that enables subscribers to inexpensively send, receive, and transfer telephone calls, email messages, voice mail messages, paging messages, and facsimile messages.

### BACKGROUND OF THE INVENTION

In today's society, people use a multitude of different services to communicate with one another. Wireline telephone services, cellular telephone service, facsimile messages, email messages, voice mail messages, pager services, and Internet access services are just some of the important methods and services widely used for business and personal communications. For many different purposes, people require the ability to send and receive messages, access information, conduct business transactions, organize daily schedules, and stay in touch with homes and offices from almost anywhere, at any time, in an easy to use and economical manner.

Continued demand for products and services that address these communication needs is evidenced by the increasing number of portable electronic devices, such as cellular telephones, pagers, and Personal Digital Assistants (PDAs). Furthermore, the explosive growth of Internet and related networking services demonstrates the importance of such systems to personal communications and the ability to quickly and easily access information.

Devices such as notebook and sub-notebook computers containing modems (both wireless and wireline) have allowed mobile professionals to connects their PC's to data networks from almost any location and to gain access to online information and electronic mail services while traveling worldwide.

In addition, communication and information needs have stimulated the growth of the Internet, online networks and corporate intranets. These networks currently host a variety of services such as contact lists, scheduling and date book information, electronic mail, conferencing, electronic commerce, games, software libraries and electronic newspapers and magazines.

Despite the proliferation of communication devices and the development of the Internet and other business networks, significant barriers remain to fulfilling a user's needs for a simple and economical system allowing access to not only personal information, but also professional and public information.

The hardware designs and software technologies that enable today's communication are complex and expensive. User's must often maintain multiple different devices (i.e., a cell phone, a fax machine, and a computer) in order to utilize the available communication opportunities. Further, a user is often require to pay for multiple service subscriptions, such as cellular service, Internet service, and wireline telephone service. Therefore, it can become quite costly for a user to take full advantage of the communication services required by the user.

Additionally, interfacing all of the available communication services with one another is a very complex task. Each service provider organizes data differently, uses different hardware, and charges a variety of different fees depending upon the activities of the user.

The problem of accessing and processing all of the available information from communication systems, networks and services is particularly acute for mobile business professionals. The mobile professional, whether working out of the home or while on the road, may have a cellular telephone, a facsimile machine, a pager, intranet mail, Internet mail, and voice mail services. Success for this professional, depends in large part on the ability to easily, quickly and inexpensively access, sort, and respond to the messages delivered to each of these communication devices and on the ability to obtain necessary information to conduct business within proliferating networks and services.

Therefore, a need exists for a system and method for providing an integrated communications system that bundles all services required by users.

### SUMMARY OF THE INVENTION

It is an object an embodiment of the present invention to provide a system and method for providing a bundle of communication services from a single provider.

A further object of an embodiment of the present invention is to provide a system and method for interfacing a plurality of different communication services enabling each service to transfer data and calls to another service.

Another object of an embodiment of the present invention to provide a reduced cost system and method for transferring data and calls to multiple locations.

The present invention relates to a unified communications system. The communications system provides a variety of different communication services to a user from a single service provider. These services include local telephone service, long distance, cellular telephone service, Internet access, voice mail, email, facsimile service, and paging services. Each of the different communication services are linked together by a control system operated by a single service provider. The unified system allows users to easily and economically transfer information received by one of the communication services to a second communication services.

An embodiment of the present invention is a communications system operated by a single service provider. The system includes a control system that interfaces all of the different communications services offered by the service provider. The system implements speech recognition technology thereby allowing users to control all of the communication services uses speech commands. Further, the communications system provides a single operating menu that allows users to control and access all of the features and services provided by the system. This operating menu may be accessed using speech commands, touch-tone commands, or via a computer.

### BRIEF DESCRIPTION OF THE DRAWINGS

FIG. 1 is a block diagram showing methods available for users to access the communications system of the preferred embodiment,

FIG. 2 is a block diagram of a control system used with the preferred embodiment; and

FIG. 3 is a block diagram of the various services that may be provided by single service provider according to the preferred embodiment.

### DETAILED DESCRIPTION OF THE PREFERRED EMBODIMENT

The preferred embodiment of the present invention comprises a single communications system that provides a plurality of the communication services required by users to effectively communicate with others and manage personal, as well as business, information. The system of the preferred embodiment is capable of providing users with the following services for home and business uses: local telephone service, cellular telephone service, long distance service, Internet access service, and a variety of messaging services that include voice mail, facsimile, electronic mail (“email”), and paging. The system provides users with the option to obtain multiple email and voice mail accounts. Further, the system allows users to select either dial-up Internet access service or to broadband Internet access service, which includes Digital Subscriber Line service (DSL) and cable modem service.

Although a user may subscribe to these services from individual providers, a communications system allowing a user to subscribe to each of these services from a single provider enables each service to be integrated together and operate seamlessly to the user. This integration allows each service to easily and efficiently communicate with and transfer data to other services as will be described below. A user also acquires these services from many different companies is subject to incompatibility problems which resulting from the varying products used by the different companies. The system of the preferred embodiment eliminates these incompatibility problems since all services are provided by the same company. This ability to eliminate incompatibility problems can improve user interest in the “collectively bundled” group of services made available by the provider. Further, significant cost economies can be realized by a service provider with the ability to offer a “collectively bundled” group of services. These cost economies can improve customer satisfaction with the service provider

Providing a bundle of services, as described by the preferred embodiment, enables the service provider to lower the unit costs for each service since a user will be subscribing to a several services provided by the same company. Several economic advantages will also be realized by the service provider. First, much of the infrastructure (i.e, hardware and software) required for a service provider to provide the various services can be used for multiple services. Therefore, as the number of different services offered by a service provider increases, the less the amount of expenditures that need to be made for capital improvements. Second, the provider will be able to market a wide variety of services to users, each of which can be offered at a lower per unit cost than competitors. Further, the service provider will be able to actually increase revenues since it has the ability to provide multiple services.

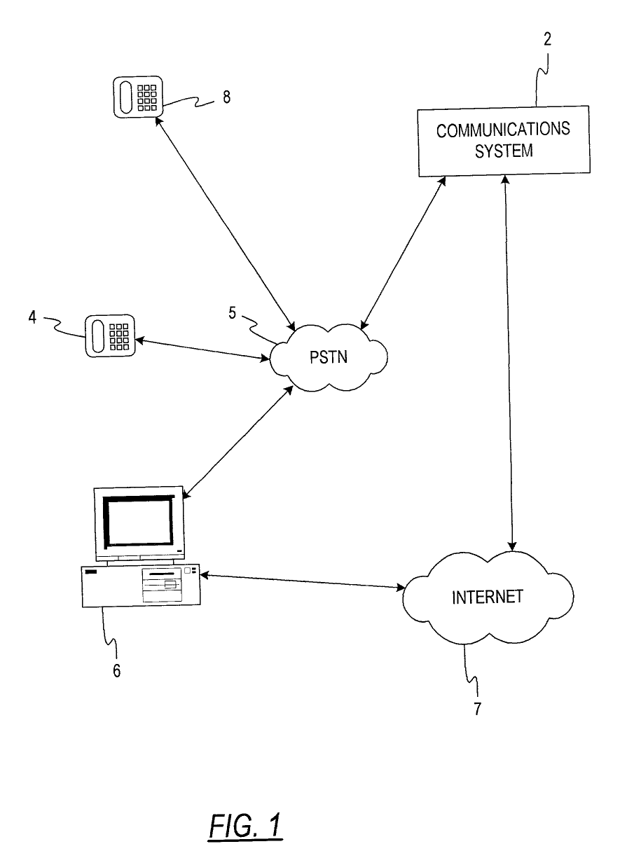

Referring to FIG. 1, the communications system 2 of the preferred embodiment may be accessed by users via a voice enabled devices 4 (i.e., any type of wireline or wireless telephone, Internet Protocol (IP) phones, or other special wireless units) or a computer 6 using a modem or other communication connection (i.e., Digital Subscriber Line connection, cable modem, LAN, or WAN). A user accesses the communications system 2 via a telephone by calling a toll-free number.

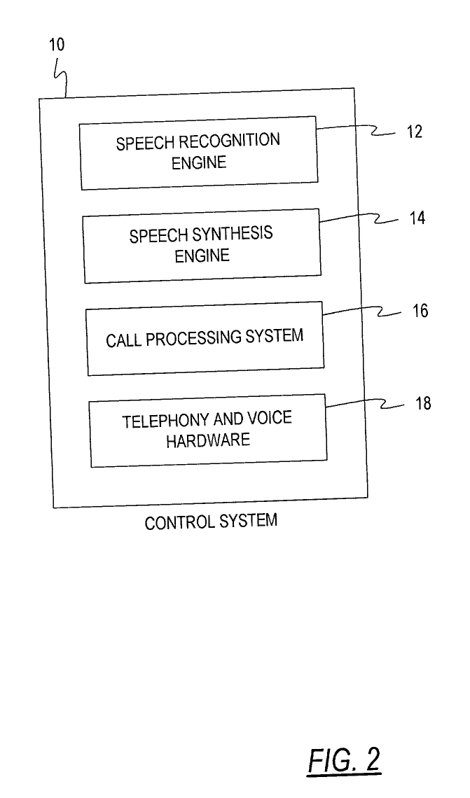

FIG. 2 depicts a control system 10 used with the communications system 2 of the preferred embodiment. The control system 10 functions as a central system that monitors and controls the features, services, and functions of the communications system 2. When a user accesses the control system 10, he is presented with an operating menu that enables the user to control all of the services and features of the communications system 2. The control system 10 provides three methods for a user to access the operating menu and handle his communications.

First, the control system contains a speech recognition software engine 12. This speech recognition engine 12 uses phonemes to recognize speech commands. Therefore, the speech recognition engine can recognize naturally spoken speech commands and is speaker-independent; it does not have to be trained to recognize the speech patterns of each individual user. A preferred speech recognition engine is developed by Nuance Communications of 1380 Willow Road, Menlo Park, Calif. 94025 (www.nuance.com). The natural speech recognition grammars (i.e., what a user can say that will be recognized by the speech recognition engine) were developed by Webley Systems.

The control system 10 also contains a speech synthesis software engine 14 that converts text messages into audio messages that may be transmitted to a user. A preferred speech synthesis engine is developed by Lernout and Hauspie Speech Products, 52 Third Avenu, Burlington, Mass. 01803 (www.lhsl.com). The control system 10 also contains a call processing system 16 and telephony and voice hardware 18 required to interface the communications system 2 with the Public Switched Telephone Network (PSTN) 5.

A user may also access the communication system 2 using the touch-tone signals provided by the users voice enabled device 4, such as a telephone. The third option a user has for accessing the communication system 2 is via a computer 6. Regardless of the method used to access the communications system 2, a user may access and control all of the available features and services of via the operating menu provided by the control system 10. The user's computer 6 may be connected directly with the communication system 2 using a modem and the Public Switched Telephone Network (PSTN) 5, or via the Internet 7.

When an outside caller 8 dials a telephone number associated with the communications system 2, the caller 8 is asked by the control system 2 to state the name of the user attempting to be reached. The voice recognition engine 12 will recognize the particular user name and transfers the caller to the user. The transferring features of the preferred embodiment will be discussed in more detail below.

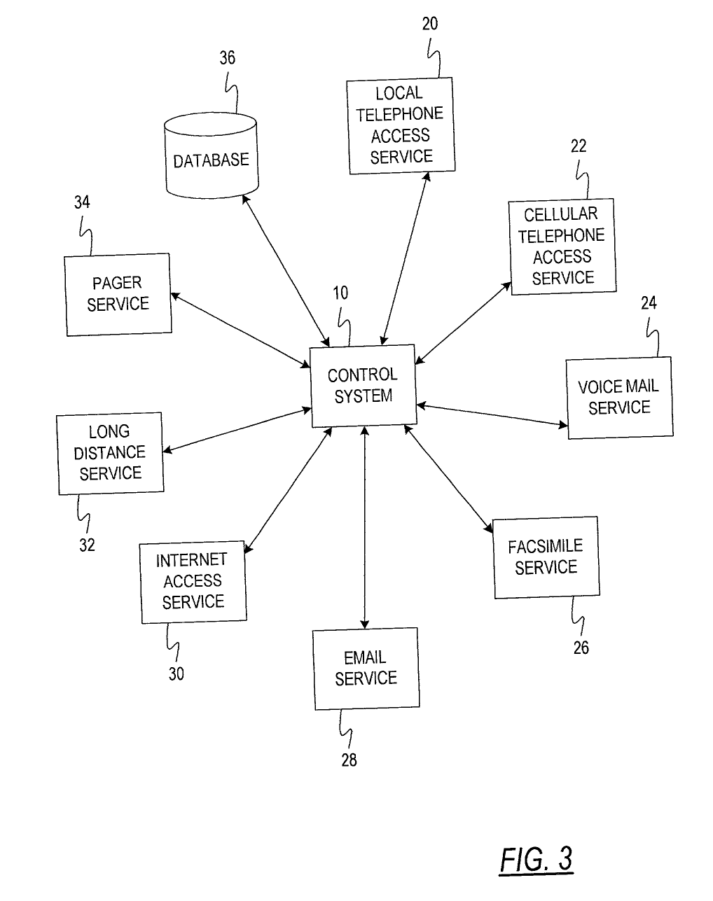

Referring to FIG. 3, the configuration of the communications system 2 of the preferred embodiment will now be described. The communications system 2 comprises a control system 10 that is a central system connected to a variety of different communication services. One possible method of connected the control system 10 with the various communication services is using a ring-type connection similar to a token ring. The services connected to the control system 10 in the preferred embodiment include a local telephone access service 20, a cellular telephone service 22, a voice mail service 24, a facsimile service 26, an email service 28, an Internet access service 30, a long distance service 32, and a pager service 34. These services may also be sub-divided into “business” related services on “home” related services. That is, the local telephone service may be sub-divided into “home local telephone access” and “business local telephone access”. It is contemplated that this sub-division of services between home and business can be done for any or all services and one skilled in the art would understand how to do so. Further, the local telephone access service 20 is typically provided as a landline service (i.e, it is a non-wireless service). The local telephone access service 20 may also be provided using voice-over-IP technology. This allows telephone calls to be established using a data network such as the Internet.

The control system 10 can communicate with all of the services 20, 22, 24, 26, 28, 30, 32, and 34. Therefore, the control system 10 provides an interface between all of the services 20, 22, 24, 26, 28, 30, 32, and 34. By communicating through the control system 10, all of the services are able to communicate with each other. This enables a call being handled by the cellular telephone service 22 to be transferred to the voice mail service 24. Further, this arrangement allows a call being handled by the local telephone access service 20 to transfer the call to a user's cellular telephone, via the cellular telephone service 22, or to be transferred to the voice mail service 24. This example demonstrates a unique advantage of the preferred embodiment. A single voice mail service 24 can be used to record messages from callers that have called either a user's cellular telephone or wireline telephone (the telephone associated with the local telephone access service). Therefore, a user who subscribes to these three services will be provided with the advantage of being able to retrieve all voice mail messages from one location.

As mentioned, the preferred embodiment of the present invention allows calls to easily be transferred between services. This feature is very crucial for busy professionals. The control system 10 can transfer calls, email messages, facsimile messages, or voice mail messages between any of the services that are part of the communications system 2. A user can therefore instruct the control system 10 to forward any received email messages to a local facsimile machine specified within the facsimile service 26. Alternatively, facsimile messages received for a user may be subsequently forwarded to a user's email address maintained by the email service 28. The ability of the communications system 2 to provide users with a variety of options for receiving and routing messages and calls are beneficial features for users. These options provide users with an added level of control over how they manage information and communicate with others.

The communications system 2 of the preferred embodiment also enables users to transfer telephone calls to other locations for a reduced fee. The service provider may easily monitor the number of call transfers attempted by the user. The service provider may allow a user to transfer a received call to one location free of charge. Any additional transfers would be subject to a fee. For instance, a user may specify that all incoming calls to the communications system 2 for a user should be transferred to a business telephone. This transfer would be done free of charge. However, if the user decides to transfer the call to an additional device, such as a cellular telephone, the user would be charged for this additional transfer.

This method for transferring telephone calls would present a substantial reduction in costs for cellular telephones users who subscribe to the cellular service 22 of the communications system 2. Most cellular service providers charge per minute fees for any call received on a cellular telephone. However, if a user obtains his cellular service from a company providing “collectively bundled” services according to the preferred embodiment, then all calls that are initially transferred to this cellular telephone from the control system 10 would be free. No per minute usage fees would be charged. This would present a dramatic cost reduction for most users who previously possessed cellular service from an outside provider.

The ability of the preferred embodiment to transfer received telephone calls to any of the services shown in FIG. 3 allows a service provider to provide a “Follow Me” feature. This feature allows users to instruct the communications system 2 to forward received calls to a second telephone number if the user does not answer the call at the first designated telephone number. Users can program the communications system 2 to “follow” the user by sequentially transferring a received call to different locations or services communications devices until the user is contacted. The user can create a list of predetermined contact numbers used by the system 2 in trying to locate the user. This list may include telephone numbers for office, home, cellular telephone, pager and other designated locations. The user may also indicate the order in which the system 2 should call each of the numbers in trying to locate the user.

The “Follow Me” feature also logs the originating telephone number used by the user when accessing the communications system 2 to retrieve stored messages or make a telephone call. A user can instruct the system 2 to subsequently use this number to recontact the user when an incoming call is received for that subscriber. For example, a user may be traveling and have the communications system 2 forward all telephone calls to the hotel room where the user is staying. Further, since the communications system is accessible via the telephone, the user is able to obtain and send messages from the hotel telephone.

When a user receives a call that is transferred from the communications system 2, the system advises the user of the telephone number of the calling party, and/or the callers identity. The system may recognize the caller's identity by comparing the telephone number of the caller with a user's contact list which is stored within a database 36 connected with the control system 10. If the user is already on the telephone when a new call is received, the system will whisper the pending inbound call information to the user, allowing the user the option to take the call, thereby putting the user's current call on hold, or direct the pending inbound call into the user's voice mail system provided by the voice mail service 24.

The integrated nature of the services provided by the preferred embodiment allows a user to either retrieve email messages using an Internet connection to the communication system 2 or retrieve then by having then read to the user over a telephone using the speech synthesis engine 14. The integrated features of the communications system enables users to immediately respond to email messages by another email message, a voice mail message, or placing a call to the originator of the email message. A speech-to-text feature enables users to create email messages using only a telephone. Additionally, the speech recognition feature discussed above allows users to edit, forward, saving or deleting email messages using speech commands and a telephone.

The speech synthesis engine 14 may also be used by users to review by telephone facsimile messages received by the facsimile service 26. Further, the speech-to-text feature may be used to create facsimile messages by telephone. The user may then issue speech commands, which are recognized by the speech recognition engine 12, to send, edit, forward, or delete the existing or newly created facsimile messages.

The communication system 2 of the preferred embodiment also contains a “notification” software engine that enables users to be notified of messages received by the system. For example, a user can program the communications system 2 to notify the user via a pager, using the paging service 34, when an incoming message has been received. This notification can further indicate whether the incoming message is a voice mail, email, or a facsimile message.

As previously mentioned, the communications system 2 of the preferred embodiment enables users to maintain a contact list maintained in a database 36 accessible by the control system 10. This contact list enables users to broadcast email, voice mail, or facsimile messages to groups of contacts. This contact list can be accessed by the user at anytime using either an Internet connection or telephone connection with the communications system 2. The speech recognition engine 12 described above enables users to access and edit the contact list and send messages to contacts by using simple speech commands.

The “collectively bundled” communication system of the preferred embodiment also allows users to retrieve, on demand or at predetermined intervals, selected information from the Internet. A user may establish predefined Internet searches using the Internet access service 16 of the communications system 2. The user can then specify that the Internet access service 16 perform the search using an Internet search engine (e.g., www.yahoo.com). The search can be performed upon receiving a speech command from the user or it may periodically be executed based upon a schedule set by the user. The control system 2 would then notify the user of the search results using the method specified by the user. For example, the user may select to by notified of the search results by email, voice mail, or facsimile. Additionally, the speech synthesis engine 14 may be used to read the search results to the user over a telephone connection.

As mentioned, a user can access the communication system 2 via a computer 6. The system 2 allows a user to access and play voice mail messages (using a downloadable audio player, such as RealPlayer, obtainable from www.real.com), read and send email and facsimile message, and manage the user's contact list using computer connection established through the Internet access service 30 or through a direct dial-up connection using the local telephone access service 20.

The descriptions of the preferred embodiments described above are set forth for illustrative purposes and are not intended to limit the present invention in any manner. Equivalent approaches are intended to be included within the scope of the present invention. While the present invention has been described with reference to the particular embodiments illustrated, those skilled in the art will recognize that many changes and variations may be made thereto without departing from the spirit and scope of the present invention. These embodiments and obvious variations thereof are contemplated as falling within the scope and spirit of the claimed invention.

We claim:

1. A unified communications system, comprising:
a plurality of communication services, including at least a local telephone service, a cellular telephone service, an Internet access service, an email service, a voice mail service, a pager service, a facsimile service, and a long distance service,
a single service provider configured to provide each of said communication services to a user;
a single CPU-based control system configured to interface with each of said communication services, said control system including at least a speech recognition engine, a speech synthesis engine, and a call processing system,
an operating menu configured to enable said user to control by speech commands all of said services interfaced with said control system, and
a notification engine configured to transmit a notification message from said control system to said user indicating that a message that has been received for said user and also indicating the message type.

2. A method for providing a unified communications system comprising the steps of
providing local telephone, cellular telephone, Internet access, email, voice mail, pager, facsimile, and long distance services to a user from a single service provider,
interfacing each of said services with a single CPU-based control system, said control system including at least a speech recognition engine, a speech synthesis engine, and a call processing system;
providing an operating menu to said user enabling said user to control all of said services interfaced with said control system,
receiving a speech command from said user for controlling each of said services according to said operating menu,
receiving a message destined for said user, said messaging including a voicemail message, email message, or a facsimile message; and
transmitting a notification message from said control system to said user indicating that a message has been received and the message type
